(19) United States
(12) Patent Application Publication
(10) Pub. No.: US 2022/0058727 A1
(43) Pub. Date: Feb. 24, 2022

(54) JOB BASED BIDDING

(71) Applicant: Core Scientific, Inc., Bellevue, WA (US)

(72) Inventors: Max Alt, San Francisco, CA (US); Jesse Barnes, Sebastopol, CA (US)

(21) Appl. No.: 17/405,370

(22) Filed: Aug. 18, 2021

Related U.S. Application Data
(60) Provisional application No. 63/066,986, filed on Aug. 18, 2020.

(51) Int. Cl. G06Q 30/08; G06F 11/34; G06F 9/50

(52) U.S. Cl. CPC G06Q 30/08; G06F 11/3442; G06F 9/5044; G06F 11/3428

(57) ABSTRACT

A system and method for job-based bidding for application processing work is disclosed. The system may include interfaces for submitting requests for bids (RFBs) and corresponding offers. The system may allow pricing based on the type of application and the quantity and type of work primitive to be processed, and it may use prior captured performance data to calculate estimated per unit of work costs that can be translated to different system types based on their capabilities. This per unit of work cost may assist providers in making offers on the RFBs. Recommended job requirements may also be generated. Once an offer is accepted, the system may configure and dispatch the job to the appropriate provider computing queue(s).

### CROSS-REFERENCE TO RELATED APPLICATIONS

This application claims the benefit of, and priority to, U.S. Provisional Application Ser. No. 63/066,986, filed Aug. 18, 2020, the disclosure of which is hereby incorporated herein by reference in its entirety and for all purposes.

### TECHNICAL FIELD

The present disclosure generally relates to the field of computing and, more particularly, to systems and methods for handling batch jobs in distributed multi-provider computing systems.

### BACKGROUND

This background description is set forth below for the purpose of providing context only. Therefore, any aspect of this background description, to the extent that it does not otherwise qualify as prior art, is neither expressly nor impliedly admitted as prior art against the instant disclosure.

For modern high-performance workloads such as artificial intelligence, scientific simulation, and graphics processing, measuring application performance is particularly important. These high-performance computing (HPC) applications (also called workloads or jobs) can take many hours, days or even weeks to run, even on state-of-the-art high-performance computing systems with large numbers of processors and massive amounts of memory. HPC applications may be run on a variety of different types of HPC computing systems, including for example distributed computing clusters, bare-metal systems, virtual instances running on cloud providers' infrastructure, and even super computers.

These HPC computing systems are typically very expensive to acquire, operate (e.g., power costs), and maintain (e.g., support contracts, replacement parts). For these reasons, owners of HPC computing systems are continually looking for ways to reduce or offset their operating expenses. Due to this high cost, users that only occasionally need HPC computing systems may not be able to afford their own dedicated system. Instead, they often look to cloud computing providers. However, these cloud computing services can be expensive as well. For this reason, users of HPC computing systems are continually looking for ways to reduce their cloud computing costs.

In cluster and cloud computing HPC environments, it's common for users to run so-called “batch” jobs, which can be queued to run when processing is available and have a definite lifetime (for example, a computational fluid dynamics simulation). Some cloud providers provide dynamic pricing systems (e.g., Amazon Web Services “spot market” for compute instances) that can be useful for these types of workloads. However, the pricing on this spot market can still be prohibitive for some workloads. For at least these reasons, an improves system for matching workloads with computing providers is desired.

### SUMMARY

A system permitting users to request bids for their batch jobs from a diverse set of computing service products is contemplated. Current systems do not provide users with the ability to request bids for their well-defined batch jobs from a diverse set of computing service providers based on the specifics of their application and the work items being performed. In some cases, this may be desirable, e.g., in an environment built around a specific area of expertise like cryogenic electromagnetic imaging. Compute cluster providers may have intimate knowledge of the related applications and be able to provide a user community with value-based pricing around their particular applications. One advantage of such a system is that compute providers may have resources of different kinds to offer, for example specialty FPGA-based nodes or GPU-enabled nodes that can complete the job quickly but at a high cost, or nodes with older CPUs or I/O subsystems, which can complete the job cheaply albeit with a longer duration. In such an environment, users may take advantage of the options on offer depending on their particular needs.

A system is contemplated to allow a privately defined marketplace of users and compute resource providers (“providers”) to exchange offers and bids for individual executions of specific applications (“batch jobs” or “jobs”) based on the specifics of the application and primitives (e.g., work items) to be processed. In one embodiment, providers (who may have expertise or experience in a particular type of processing) may be provided with information about these primitives and estimated cost per unit of work, so they can provide informed offers to execute the jobs for credits or specific dollar amounts. The system may collect the necessary information from users into a request for bid package, notify the available providers, and allow them in turn to reply with offers to run the job, including price and specific compute resource configurations.

In one embodiment, the system comprises several elements, including but not limited to an end user job configuration and request for bid creation system, a notification system for providing both users and providers with information about bids (both requests and offers), a provider system for generating offers for specific user requests, and a management system for both users and providers to view, update, or delete their requests or offers as appropriate.

In one embodiment, the job configuration and RFB system may request several elements from the user, including application information, input data (if any), application configuration, and a deadline for the job to complete. This information may be packaged into a request, and in response the system may notify any interested providers of the request. Other embodiments may include other information, for example user estimates of the job runtime for a specific configuration of compute resources, details on the input data set, the type of application, the type and number of primitives or work items to be processed, or other information to allow providers to provide more detailed offers.

In one embodiment, the provider may create offers that include computational details such as the number and type of CPUs or GPUs that will be used, along with a price. Other embodiments may include ancillary services such as optimization work or data storage. Some embodiments of the system may also include a request and offer management system, allowing both users and providers to view outstanding bids, rescind offers or requests, and accept offers. A notification system may also be included. For example, in an online portal embodiment, an email or in-application pop up window might be desired to inform marketplace participants of new RFBs.

In one embodiment the method may include operating an automated marketplace and may comprise maintaining a roster of available computer systems (e.g., different computing systems and or configurations available from a plurality of different cloud computing providers) and collecting and storing performance data (e.g., in a database) for one or more applications (e.g., benchmarks, simulations) executing on those computer systems. In response to receiving a request for bid for a job, a job cost estimate may be determined for each of the available computer systems based on the stored performance data, and the user may be presented with a list of computing systems from the roster that are suitable for executing the job based on the estimated job cost. The estimate may be based on a calculated per-unit of work job cost (e.g., per model evaluated, per work item or primitive rendered, etc.) that may be translated to account for the differences in the various computing systems options based on configuration information and performance data collected when the various computing systems entered the marketplace. For example, a computing system with GPUs may be significantly more efficient in executing a particular large-scale rendering operation than a supercomputer cluster relying only on a large number of CPUs. Once the user selects one of the options, the system may automatically configure the job for the selected option and deploy it.

The system may support optional user-specified job requirements (e.g., providing a whitelist of countries where the processing may take place, or requiring a certain minimum bandwidth interconnect between nodes). In some embodiments, the system itself may make job requirement recommendations based on the stored performance data in the database. For example, if the previously collected performance data indicates that a particular type of computational fluid dynamics (CFD) simulation benefits from a high memory bandwidth, the system may propose a minimum memory bandwidth requirement for similar CFD simulation jobs.

To continue to grow the database, the system may be configured to capture performance data for jobs executed through the marketplace. In some embodiments, the system may be configured to perform one or more short test runs of a user-submitted job on one or more of the computing systems in the marketplace. Performance data for the test run may be collected and used to assist in profiling the application and determining execution time and cost estimates. This test performance data may also be used to find similar applications in the database in order to make the job requirement recommendations.

A batch job bidding system is also contemplated. In one embodiment, the system may comprise a first interface for users to create and submit RFBs for a computing job, and a second interface for providers to submit information usable to determine eligibility for the request for bid and to generate offers in response to the request for bid. A database may be used to store performance data for a number of historical jobs that were executed on various computing systems participating in the bidding system. The system may have a job estimator that estimates a compute time for the computing job based on the historical stored job performance data and or a test run of the application on one or more of the various participating computing systems. The system may also have a cost estimator that estimates a cost for the computing job for various different providers (e.g., cost per unit of work); and a bid manager that generates a list of offers for the RFB. The job estimator may be configured to profile the computing job and make one or more job requirement recommendations based on the stored performance data for similar historical jobs, and a job dispatcher may be included to automatically configure and deploy containers for the computing job based on the historical stored performance data.

In another embodiment, the method comprises receiving a request for bid (RFB) from a user, where the RFB comprises an application, configuration information (e.g., the number of nodes needed, the type of application and work item primitives to be processed), and input data (e.g., data files for use in a simulation run). The request for bid may be forwarded to a number of different marketplace participant computing service providers. The marketplace may add additional information e.g., predicted cost per unit of work to assist providers in making offers or evaluating marketplace-generated recommended offers. Offers from at least a subset of the computing service providers are received, and a list of the received offers is presented to the user. Once an option is selected, the application, configuration information, and the input data are sent to the selected computing service provider for queuing and execution.

The foregoing and other aspects, features, details, utilities, and/or advantages of embodiments of the present disclosure will be apparent from reading the following description, and from reviewing the accompanying drawings.

### BRIEF DESCRIPTION OF THE DRAWINGS

FIG. 1 is an illustration of one example of a distributed computing system and marketplace.

FIG. 2 is a flowchart of an example embodiment of a method for processing computing jobs in a distributed computing system marketplace.

FIG. 3 is a system diagram of an example embodiment of a system for processing computing jobs via a marketplace.

FIG. 4 is a flowchart of another example embodiment of a method for processing computing jobs in a distributed computing system marketplace.

### DETAILED DESCRIPTION

Reference will now be made in detail to embodiments of the present disclosure, examples of which are described herein and illustrated in the accompanying drawings. While the present disclosure will be described in conjunction with embodiments and/or examples, it will be understood that they do not limit the present disclosure to these embodiments and/or examples. On the contrary, the present disclosure covers alternatives, modifications, and equivalents.

Various embodiments are described herein for various apparatuses, systems, and/or methods. Numerous specific details are set forth to provide a thorough understanding of the overall structure, function, manufacture, and use of the embodiments as described in the specification and illustrated in the accompanying drawings. It will be understood by those skilled in the art, however, that the embodiments may be practiced without such specific details. In other instances, well-known operations, components, and elements have not been described in detail so as not to obscure the embodiments described in the specification. Those of ordinary skill in the art will understand that the embodiments described and illustrated herein are non-limiting examples, and thus it can be appreciated that the specific structural and functional details disclosed herein may be representative and do not necessarily limit the scope of the embodiments.

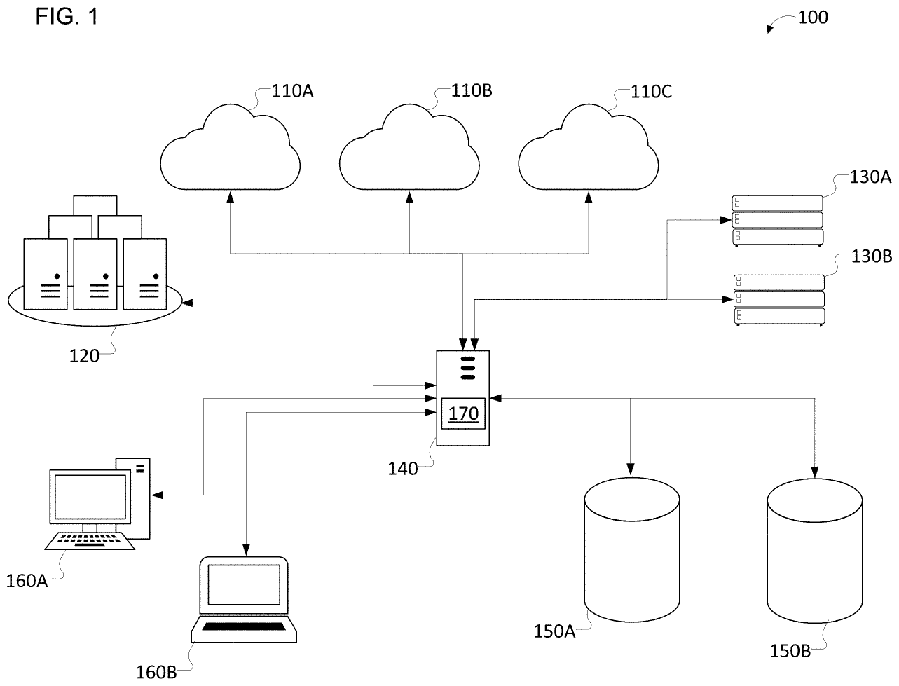

Turning now to FIG. 1, an example of a distributed computing system 100 is shown. In this example, the distributed computing system 100 is managed by a management server 140, which may for example provide access to the distributed computing system 100 by providing a platform as a service (PAAS), infrastructure as a service (IAAS), or software as a service (SAAS) to users. Users may access these PAAS/IAAS/SAAS services from user devices 160A and 160B such as on-premises network-connected PCs, workstations, servers, laptops, or mobile devices via a web interface.

Management server 140 is connected to a number of different computing devices via local or wide area network connections. This may include, for example, cloud computing providers 110A, 110B, and 110C. These cloud computing providers may provide access to large numbers of computing devices (often virtualized) with different configurations. For example, systems with a one or more virtual CPUs may be offered in standard configurations with predetermined amounts of accompanying memory and storage. In addition to cloud computing providers 110A, 110B, and 110C, management server 140 may also be configured to communicate with bare metal computing devices 130A and 130B (e.g., non-virtualized servers), as well as a data center 120 including for example one or more high performance computing (HPC) systems (e.g., each having multiple nodes organized into clusters, with each node having multiple processors and memory), and storage systems 150A and 150B. Bare metal computing devices 130A and 130B may for example include workstations or servers optimized for machine learning computations and may be configured with multiple CPUs and GPUs and large amounts of memory. Storage systems 150A and 150B may include storage that is local to management server 140 and well as remotely located storage accessible through a network such as the internet. Storage systems 150A and 150B may comprise storage servers and network-attached storage systems with non-volatile memory (e.g., flash storage), hard disks, and even tape storage.

Management server 140 is configured to run a distributed computing management application 170 that receives jobs and manages the allocation of resources from distributed computing system 100 to run them. Management application 170 is preferably implemented in software (e.g., instructions stored on a non-volatile storage medium such as a hard disk, flash drive, or DVD-ROM), but hardware implementations are possible. Software implementations of management application 170 may be written in one or more programming languages or combinations thereof, including low-level or high-level languages, with examples including Java, Ruby, JavaScript, Python, C, C++, C#, or Rust. The program code may execute entirely on the management server 140, partly on management server 140 and partly on other computing devices in distributed computing system 100.

The management application 170 provides an interface to users (e.g., via a web application, portal, API server or command line interface) that permits users and administrators to submit applications/jobs via their user devices 160A and 160B such as workstations, laptops, and mobile devices, designate the data sources to be used by the application, designate a destination for the results of the application, and set one or more application requirements (e.g., parameters such as how many processors to use, how much memory to use, cost limits, application priority, etc.). The interface may also permit the user to select one or more system configurations to be used to run the application. This may include selecting a particular bare metal or cloud configuration (e.g., use cloud A with 24 processors and 512 GB of RAM).

Management server 140 may be a traditional PC or server, a specialized appliance, or one or more nodes within a cluster. Management server 140 may be configured with one or more processors, volatile memory, and non-volatile memory such as flash storage or internal or external hard disk (e.g., network attached storage accessible to management server 140).

Management application 170 may also be configured to receive computing jobs from user devices 160A and 160B, determine which of the distributed computing system 100 computing resources are available to complete those jobs, make recommendations on which available resources best meet the user's requirements, allocate resources to each job, and then bind and dispatch the job to those allocated resources. In one embodiment, the jobs may be applications operating within containers (e.g. Kubernetes with Docker containers) or virtualized machines.

Unlike prior systems, management application 170 may be configured to provide users with information about the predicted relative performance of different configurations in clouds 110A, 110B, and 110C and bare metal systems in data center 120 and bare metal systems 130A and 130B. These predictions may be based on information about the specific application the user is planning to execute. In some embodiments the management application 170 may make recommendations for which configurations (e.g., number of processors, amount of memory, amount of storage) best match a known configuration from the user or which bare metal configurations best match a particular cloud configuration.

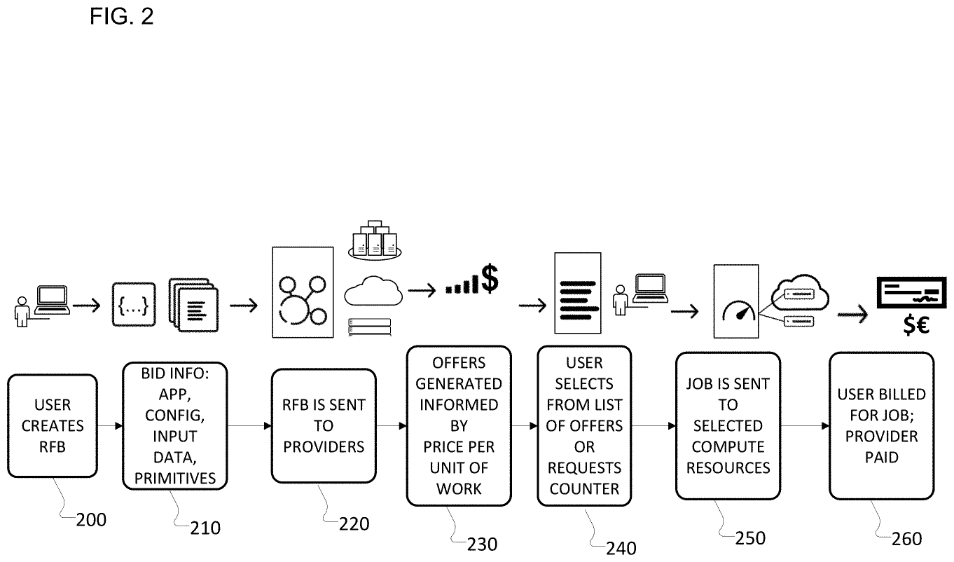

Turning now to FIG. 2, one example embodiment of a method for operating a batch job computing marketplace is shown. This method may for example be implemented in a management application 170. In this example embodiment, a user accesses a system interface (e.g. a web portal) and creates a request for bid (RFB) (step 200) for an application (i.e., job) they wish to run. The job may be a batch job or an interactive job. As part of the RFB, the user submits application-related information, including for example the actual application (e.g., source or object code), configuration information (e.g., the number of nodes, amount of memory needed, whether only CPUs are desired or CPUs and GPUs, whether any special hardware is required such as FPGAs), and the input data files to be used when executing the application (step 210).

In one embodiment, the information included in the RFB may include specifying the type of application (e.g., computational fluid dynamic problem, 3D graphic rendering, 2D image recognition, weather simulations, TensorFlow machine learning application) along with information about the quantity and type of data primitive to be operated upon (e.g., 10,000 objects to be rendered, 50,000 images to be classified, 5,000 simulations to be run). With this information, a unit of work can be defined and used to determine how long the job may require to complete (e.g., by the marketplace when providing estimates or by the providers when creating their bids). The RFB is received by the system and then sent to two or more providers of computing systems (step 220). In some embodiments, the system may filter which providers receive the RFB (e.g., based on the system's knowledge of the hardware configuration of each computing system, or geographic restrictions). The providers receive the RFBs and generate offers for running the application (step 230). For example, the offer may be a flat fee to execute the application, a per minute rate up to a hard cap, a per unit of work cost (e.g. $0.005 for each object rendered in a rendering application, or $0.10 per model tested in a scientific simulation application), or some other combination. As noted above, in some embodiments units of work are provided as part of the RFB, which allows providers to better determine their true cost on their particular system (e.g., how much electricity and for how long). For example, a particular provider may have access to historical performance data from prior runs of different jobs in the same field (e.g. different graphics rendering applications) or prior runs of the same application with different data sets that indicate the true cost per unit of work on each different system or system configuration (e.g., $0.05 per object modeled on an instance with 2 CPUs and 8 GPUs and a certain amount of memory; $0.09 per object modeled on an instance with 4 CPUs and 16 GPUs and twice the memory).

Once a predetermined amount of time has passed (e.g., either specified by the system or specified by the user when the user submits the RFB, the system collects all of the provider-submitted offers and presents them (e.g., in list form) to the user. For example, this may be presented via a web portal or an email. Once the user selects one or more of the resources to execute the job (step 240), the system then sends the job, configuration information, data files, etc. to the selected computing system or systems for execution (step 250). The user is billed for the job, and payment (e.g., the agreed upon payment minus a system commission) is passed on to the selected provider or providers (step 260).

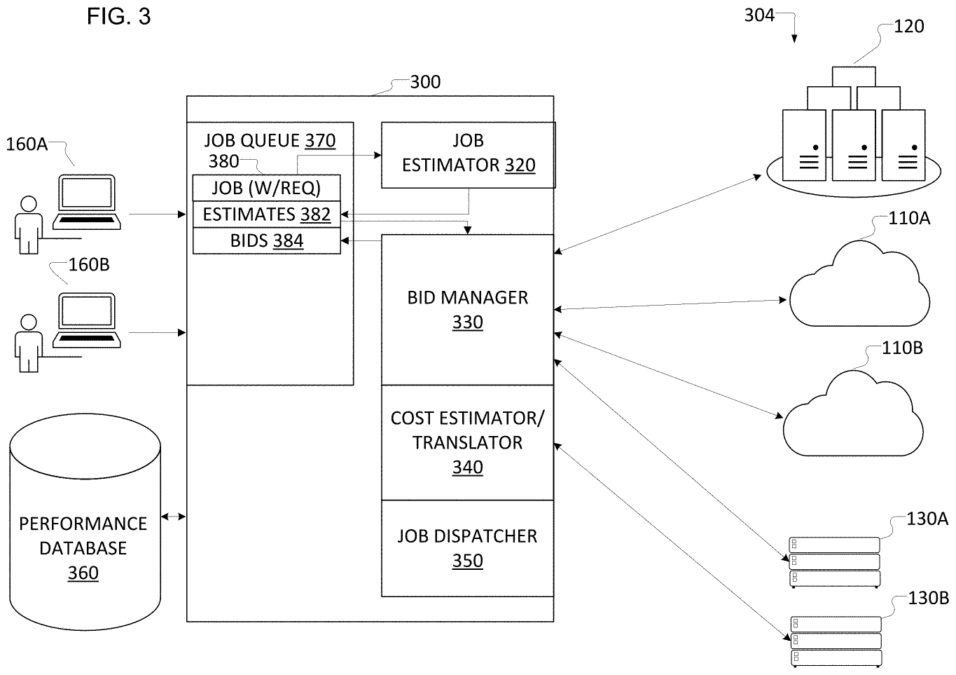

Turning now to FIG. 3, one example embodiment of a system for managing computing jobs is shown. In this embodiment, the system comprises a job management application 300 that received jobs 380 and associated request for bids from users using their user devices 160A and 160B via a first interface (e.g., such as a web portal, web app, or API accessible via a VPN or encrypted network connection) and communicates them via a second interface to a set of marketplace participant computing systems of providers 304 (e.g., operators of data center 120, providers of cloud computing providers/services 110A, 110B, 110C, and providers of bare metal systems/devices 130A and 130B). The job management application may for example be part of distributed computing system management application 170 (see FIG. 1), or a separate application (e.g., run on a server or in a cloud computing service).

Job management application 300 may include a number of component modules (e.g., processes, subroutines, functions or classes) that each perform one or more tasks. For example, when a job RFB is received, it may be checked (e.g., for proper formatting) and then placed into a job queue 370. Users may track the status of their jobs via the job queue. Received jobs may be passed to a job estimator 320 that estimates a time, quantity of processing, amount of energy or other cost measure required to perform the application. This estimate may be based on one or more data sources including for example (i) information that the user provides as part of the job RFB, (ii) computing system information such as hardware configuration information and performance on benchmarks provided by computing providers 304 as part of an initial onboarding into the marketplace, (iii) performance data collected from a test run of the job on one or more of computing systems of providers 304, (iv) historical performance data that has previously been captured and stored in performance database 360. As the hardware, speeds, and configurations of each of the computing systems of providers 304 may vary greatly, the estimate may be adjusted by cost estimator/translator 340 for each different computing system available from providers 304. For example, cost estimator/translator 340 may translate units of work across each different participant system based on their capabilities/cost and prior collected performance data that correlates the different performances of the different systems. In one embodiment, the estimates 382 created by job estimator 320 may be stored directly in the job queue 370. In another embodiment, the estimates may be first provided to providers 304 by bid manager 330 for approval/validation/adjustment before they are provided as formal bids 384 to users (e.g., via the job queue 370).

Job management application 300 may for example perform one-time or periodic testing of marketplace participant computing systems in order to populate the performance database 360 with sufficient performance data to make useful estimates and translate equivalent units of work between the different computing systems.

Once the user has selected one or more bids or estimates, the job management application 300 may be configured to use a job dispatcher 350 to configure and dispatch the job to the approved computing systems. This may for example include creating a set of containers for the application, configuring them, and the deploying them to the appropriate queues or nodes on the selected computing systems. As part of this configuration, performance monitoring may be turned on for the job so that job management application 300 may receive, process, and store performance data for the job in performance database 360. Beneficially, the more performance data samples included in performance database 360, the better the performance of job estimator 320 and cost estimator/translator 340 can be.

In one embodiment, job estimator 320 may implement hyper parameter training or Monte Carlo Analysis for conducting a quantitative analysis to consider the likelihood of different durations/costs on different hardware based on the data in the performance database 360.

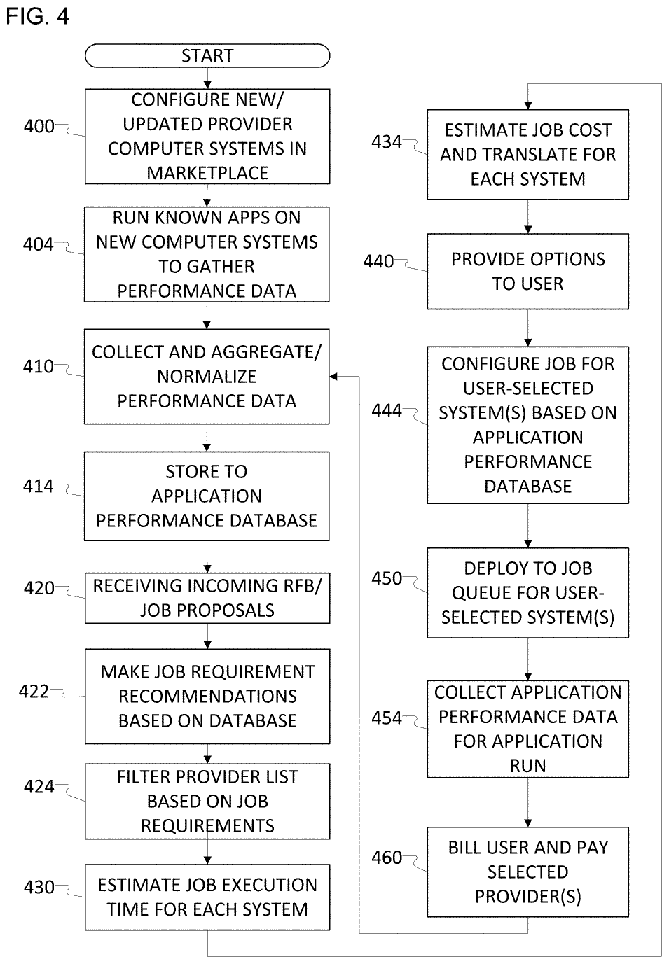

Turning now to FIG. 4, a flowchart of another method for managing job-based bidding is shown. In this embodiment, information about new provider computer systems and configurations is received (step 400) as part of signing up to participate in the marketplace (and upon any changes in system hardware or configuration). This information may include a topological representation of the computing system, the type and number of CPUs, GPUs, FPGAs, memory, interconnection type and speed, storage type and speed, network connection type and speed, cost per unit time, cost per unit of work, etc. One or more applications (e.g. benchmarks or test suites) may also be run (step 404) with performance monitoring enabled so that performance data can be collected (step 410) to assist with initial characterization of each computing system option for the provider. The data may be aggregated and/or normalized before being stored in a performance database (step 414). For example, this data aggregation may include classifying the type of application (e.g. graphics rendering, computational fluid dynamics, image classification) and the number of primitives operated on in order to develop a set of estimated execution times and or costs for different units of work. By establishing a set of common units of work, this allows estimates for a new application to be made for each participating computer systems, even though their hardware, software, interconnections, etc. may be completely different.

Incoming job proposal/RFBs are received (step 420). In some embodiments, the application that is the subject of the RFB may be tested on one or more systems to determine if any job requirements can be recommended (step 422), e.g., a minimum memory bandwidth or minimum network bandwidth. Other job requirements may be part of the RFB directly from the user (e.g. a requirement that the job be executed in a particular country, or only with a provider that has passed certain data security audits). These job requirements may be used to filter the list of providers and/or available computer systems down. (step 424).

Next, an estimated execution time may be calculated for each participant system (step 430), and a corresponding job cost may also be calculated/translated for each system (step 434). The costs may be forwarded to the providers for confirmation/adjustment, or if the provider has agreed to comply with the system's estimated pricing the costs may be auto-approved. The list of approved costs is then provided to the user (step 440). In some embodiments the user may pre-select an option when submitting their RFB (e.g., auto-approve and auto-execute on the lowest bid as long as it is below $N). In other embodiments, the user may be required to select from a presented list of options. Once the user has selected their system or systems of choice, the job may be configured for that system (step 444) and deployed (step 450). The job configuration may include performance monitoring (step 454) so that the performance database can continue to grow and improve. The user may be charged or billed (or they may have been required to pre-pay at the point of selecting their desired computing service provider and configuration), and the service provider may be paid (step 460).

Reference throughout the specification to “various embodiments,” “with embodiments,” “in embodiments,” or “an embodiment,” or the like, means that a particular feature, structure, or characteristic described in connection with the embodiment is included in at least one embodiment. Thus, appearances of the phrases “in various embodiments,” “with embodiments,” “in embodiments,” or “an embodiment,” or the like, in places throughout the specification are not necessarily all referring to the same embodiment. Furthermore, the particular features, structures, or characteristics may be combined in any suitable manner in one or more embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof.

It should be understood that references to a single element are not necessarily so limited and may include one or more of such elements. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of embodiments.

Joinder references (e.g., attached, coupled, connected, and the like) are to be construed broadly and may include intermediate members between a connection of elements and relative movement between elements. As such, joinder references do not necessarily imply that two elements are directly connected/coupled and in fixed relation to each other. The use of “e.g.” and “for example” in the specification is to be construed broadly and is used to provide non-limiting examples of embodiments of the disclosure, and the disclosure is not limited to such examples. Uses of “and” and “or” are to be construed broadly (e.g., to be treated as “and/or”). For example, and without limitation, uses of “and” do not necessarily require all elements or features listed, and uses of “or” are inclusive unless such a construction would be illogical.

While processes, systems, and methods may be described herein in connection with one or more steps in a particular sequence, it should be understood that such methods may be practiced with the steps in a different order, with certain steps performed simultaneously, with additional steps, and/or with certain described steps omitted.

All matter contained in the above description or shown in the accompanying drawings shall be interpreted as illustrative only and not limiting. Changes in detail or structure may be made without departing from the present disclosure.

It should be understood that a computer, a system, and/or a processor as described herein may include a conventional processing apparatus known in the art, which may be capable of executing preprogrammed instructions stored in an associated memory, all performing in accordance with the functionality described herein. To the extent that the methods described herein are embodied in software, the resulting software can be stored in an associated memory and can also constitute means for performing such methods. Such a system or processor may further be of the type having ROM, RAM, RAM and ROM, and/or a combination of non-volatile and volatile memory so that any software may be stored and yet allow storage and processing of dynamically produced data and/or signals.

It should be further understood that an article of manufacture in accordance with this disclosure may include a non-transitory computer-readable storage medium having a computer program encoded thereon for implementing logic and other functionality described herein. The computer program may include code to perform one or more of the methods disclosed herein. Such embodiments may be configured to execute via one or more processors, such as multiple processors that are integrated into a single system or are distributed over and connected together through a communications network, and the communications network may be wired and/or wireless. Code for implementing one or more of the features described in connection with one or more embodiments may, when executed by a processor, cause a plurality of transistors to change from a first state to a second state. A specific pattern of change (e.g., which transistors change state and which transistors do not), may be dictated, at least partially, by the logic and/or code.

What is claimed is:

1. A method for processing computing jobs, the method comprising:
maintaining a roster of available computer systems;
collecting performance data for one or more applications executing on the available computer systems;
storing the performance data to a database;
receiving a request for bid for a job;
estimating a job cost for each of the available computer systems based on the stored performance data; and
providing a subset of the available computing systems as a list of options for executing the job, wherein the subset is selected based on the estimated job cost.

2. The method of claim 1, wherein the available computer systems are from a plurality of different cloud computing providers.

3. The method of claim 1, wherein the estimating comprises:
calculating a per-unit of work job cost, and
translating that per-unit of work job based on configuration information for the available computing systems and the stored performance data.

4. The method of claim 1, further comprising:
configuring the job for a user selected one of available computing systems; and
deploying the job to the user selected one of the available computing systems, wherein the user selected one of the available computing systems is one of the subset of available computing systems.

5. The method of claim 1, wherein the list of options is also selected based on one or more job requirements.

6. The method of claim 1, further comprising making a job requirement recommendation based on the stored performance data.

7. The method of claim 4, further comprising capturing performance data for the job during execution on the user selected one of the available computing systems.

8. The method of claim 4, further comprising:
performing a test run of the job one at least one of the available computing systems;
collecting test performance data for the test run;
finding a similar application in the database based on the test performance data; and
using the similar application's performance data in the estimating.

9. The method of claim 8, further comprising:
translating units of work across the available computing systems based on each of the available computing systems' capabilities and costs and the collected test performance data.

10. A batch job bidding system comprising:
a first interface for users to create a request for bid for a computing job;
a second interface for providers to submit information usable to determine eligibility for the request for bid and to generate offers in response to the request for bid;
a database storing performance data for a plurality of historical jobs executing on a plurality of different computing systems;
a job estimator that estimates a compute time for the computing job based on the stored job performance data;
a cost estimator that estimates a cost for the computing job for one or more eligible providers; and
a bid manager that generates a list of offers for the request for bid.

11. The system of claim 10, wherein the job estimator is configured to profile the computing job and make one or more job requirement recommendations based on the stored performance data for similar historical jobs.

12. The system of claim 10, further comprising a job dispatcher that automatically configures and deploys containers for the computing job based on the stored performance data.

13. A method for operating a batch job computing marketplace, the method comprising:
receiving a request for bid for a batch job from a user, wherein the request for bid comprises an application, configuration information, input data, and a description of the batch job in units of work;
forwarding the request for bid to a plurality of computing service providers;
receiving offers from at least one of the plurality of computing service providers;
presenting a list of the received offers to the user;
receiving a selected computing service provider from the list from the user; and
sending the application, the configuration information, and the input data to the user selected computing service provider.

14. The method of claim 13, further comprising:
collecting performance data for a plurality of applications executing on one or more available computer systems from the computing service providers that are part of the batch job computing marketplace;
storing the performance data to a database; and
estimating a job cost for each of the available computer systems based on the stored performance data.

15. The method of claim 14, wherein the estimating comprises:
calculating a per-unit of work job cost, and
translating that per-unit of work job based on the stored performance data.

16. The method of claim 14, further comprising making a job requirement recommendation based on the stored performance data.

17. The method of claim 14, further comprising:
configuring the batch job for the user selected computing service provider; and
deploying the batch job to the user selected computing service provider.

18. The method of claim 17, further comprising capturing performance data for the batch job during execution on the user selected computing service provider.

19. The method of claim 14, further comprising:
performing a test run of the batch job on at least one of the available computing systems;
collecting test performance data for the test run;
finding a similar application in the database based on the test performance data; and
using the similar application's performance data in the estimating.

20. The method of claim 19, further comprising:
translating units of work across each of the available computing systems based on each of the available computing systems' capabilities and costs and the collected test performance data.
